(19) United States
(12) Patent Application Publication
(10) Pub. No.: US 2008/0256078 A1
(43) Pub. Date: Oct. 16, 2008

(54) SECURE DISTRIBUTED COMPUTING ENGINE AND DATABASE SYSTEM

(76) Inventor: Venkat Bhashyam, Woburn, MA (US)

Correspondence Address: Venkat Bhashyam, 111 Locust St, TH82, Woburn, MA, 01801, US

(21) Appl. No.: 11/733,206

(22) Filed: Apr. 10, 2007

(51) Int. Cl. G06F 17/30

(52) U.S. Cl. 707/10; 707/E17.032

(57) ABSTRACT

In this invention we present a secure distributed computing engine with a built-in distributed database system. The computing engine proposed here is capable of scaling with the network and can handle requests of generic execution types (such as calling a certain function with a set of parameters) or with regards to database manipulation as the engine includes a database management system. A client computer communicates with this computing engine over the network to send requests and receive responses. Each request a client sends is dynamically distributed among various participating computer nodes that make up the distributed computing engine. The communication channels and databases within the engine are secured at various levels using both symmetric and asymmetric encryption schemes.

### REFERENCES

Patent No.: U.S. Pat. No. 7,174,381 B2 Gulko et al.

### BACKGROUND OF THE INVENTION

In a typical networked business environment a user sends a request to a dedicated server, which processes the request and responds back to the client. If the client needs to persist this information, it processes this response and sends a new request to a different database server. Other data manipulation requests would then need to be sent to a separate database server. This mechanism has several drawbacks including extra programming work required from the client computer.

In addition, if we have several computers on our network and a client computer wants to utilize their combined computing power automatically there are currently few available solutions with limitations. All solutions before this invention were dedicated to solving the computing problem that involve mainly the use of CPUs on separate computers simultaneously or for a partially distributed database system with shared disk resource. These solutions independently are only parts of a truly distributed system. A truly distributed system gives the client computer the idea of a virtual computer that performs various types of tasks within itself and extends its capacity by simply adding more computers to the network. Such a distributed system should not rely on any external system for data storage or retrieval such as for row sets in a database table. Therefore a distributed database system shall also have the data securely distributed in addition to computing resources.

### BRIEF SUMMARY OF THE INVENTION

This invention provides a framework for a secure distributed computing platform. The distributed computing platform presented here also provides a structure for manipulating data as well. The net effect for a client computer's perspective is a virtual operating system that the client connects with and sends its computing and data manipulating requests securely. The distributed computing platform processes the request and sends a response to the client either using the same communication channel or via a new communication channel.

The invention being presented here is capable of doing the following from the perspective of the client computer:
1. A computing engine for all types of computing tasks whether parallel or serial in nature. The computing tasks may be functions to execute within a given server process or executing a command (with arguments) in a newly spawned process.
2. A truly distributed and secure database management system. The database system can take the form of a relational database system where rows within a table are distributed among several computer nodes.
3. Secure channels of communication between participating computers, therefore allowing the computing environment to grow indefinitely with the network (or internet).

### BRIEF DESCRIPTION OF THE DRAWINGS

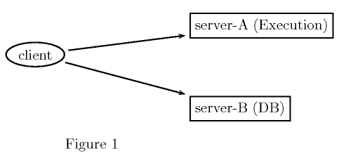

1. FIG. 1 shows a typical client server application. Client sends CPU processing work to one or more servers and then uses a database connection to persist information.

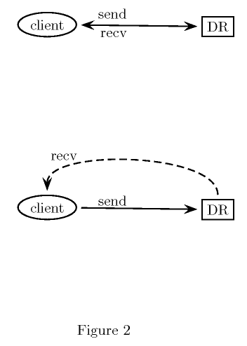

2. FIG. 2 shows connection between a client computer of this invention with a Dispatcher Responder (DR) server. The top figure shows synchronous session and the bottom shows an asynchronous session.

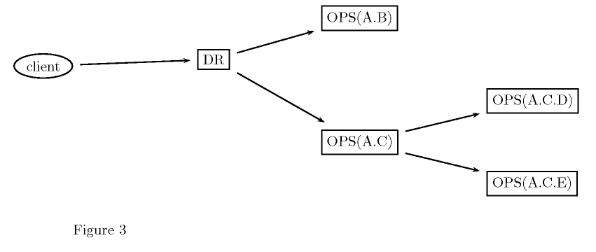

3. FIG. 3 shows overview of client's interaction with this invention. The client connects with a DR which is connected to OPSes (Operations servers) forming the topology of the computing engine. A sample topology consisting of domains is shown.

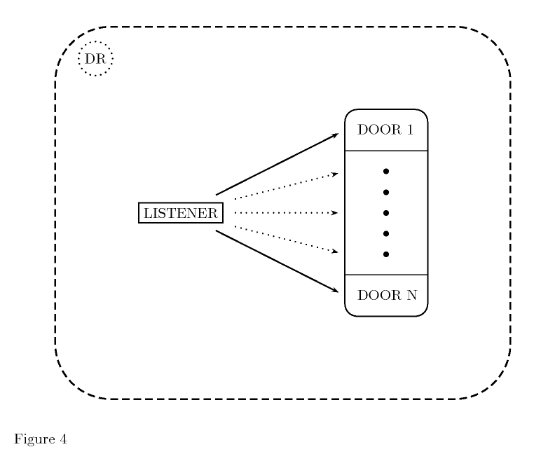

4. FIG. 4 shows a DR is composed of a “listener” process and several “door” processes.

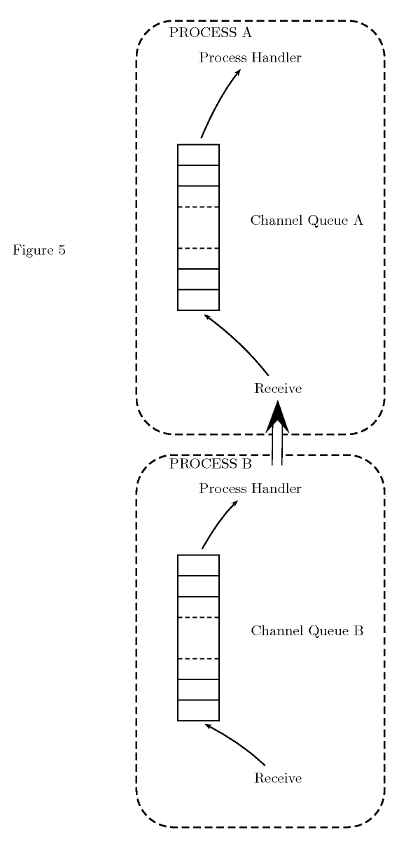

5. FIG. 5 shows how channels are used to communicate between two server processes in this invention. If the processes are on the same computer the channels use shared memory otherwise TCP/IP based communication is used.

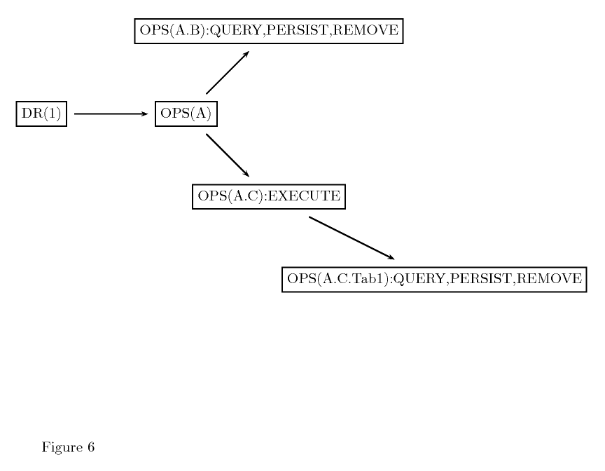

6. FIG. 6 shows requests from client are forwarded to OPSes based on availability and capability. For instance, only OPS(A.C) is capable of execution type of requests.

### DETAILED DESCRIPTION OF THE INVENTION

The computing engine is a software that runs on a set of computers that are connected to each other directly or indirectly on a network. This software enables computers to take one of the two main roles:
1. Dispatcher and Responder servers (or DR): The DR corresponds to a set of server processes within several computers that receive connections from clients and also send response back to the clients.
2. Operations servers (or OPS): The OPS corresponds to a set of server processes that have the capability of performing a set of tasks or forwarding it along to one of the other OPSes that are attached to it that can perform the task.

The above two roles are, of course, in addition to the client portion of the application that initiates requests. The client first connects to a DR and sends its authorization credentials. Once it has been accepted future communication between the client and DR can happen using this network stream or a new stream can be requested for responses to the client. The latter approach provides an asynchronous means of communication while the former gives a standard send and wait type of interaction. A network stream here is defined by IP and TCP ports of the calling client and listening server. FIG. 2 shows the two types of communication between a client and a DR.

The communication between DRs and OPSes is handled by channels whose properties (such as internet address and port etc) are stored in configuration files. The configuration files for all DRs and OPSes together also define the topology of the computing engine. FIG. 3 shows how a client interacts only with one of the DRs that is the entry point to the distributed computing software. Once a request is received, a given DR uses its list of channels to find the best suited OPS to dispatch the work. Before we go into details of DRs and OPSes we shall define our definition of a channel. A channel comes in two varieties, namely, network-based and shared-memory based.

A network-based channel is used when two processes on separate computers need to communicate with each other. In this invention networking is done using TCP/IP, therefore the end points for a network-based channel communication are IPs and ports of source and destination. The initial local topology is defined during startup using configuration files that tell each process what IPs and ports they need to use for listening or connection.

A shared-memory based channel is useful when two processes are on the same computer. Shared memory provides a much faster communication as there is no overhead of wrappers or call stack as in TCP/IP based communication. In this scenario, during process startups each process only needs to know about the shared memory handle that it needs to use for reading/writing from/to the other process. Note that shared memory based channel communication is mainly useful on a multi-CPU system where processes are specifically bound to one or more CPUs. Otherwise, the distributed computing effect is not realized to the fullest extent.

Once either of the above modes of communication is selected for a given channel the transient data being communicated to or from is placed in queues. FIG. 5 shows channel based communication between two processes named “PROCESS A” and “PROCESS B”. When “PROCESS B” needs to send a request to “PROCESS A” it sends it over a connection with “PROCESS A”. “PROCESS A” side of the channel awaits new messages and upon reception the request is decoded and added into a queue named “Channel Queue A”. As entries are added to a queue, a process handler removes entries from the other end (i.e., oldest entry) and handles the request. Because of the way channels are created and managed in order to add a new server to our topology just requires adjusting or restarting the channels related thread within the immediate server's process.

A DR collection of server processes that consist of a TCP/IP listener for client requests and a channel to one or more OPSes for dispatching them. Once the channels are established between a DR and a set of OPSes, the OPSes send internal messages to the DR. The internal messages are about the capability and resource utilization of various OPSes in the vicinity. When timely resource utilization and capability messages are not received by an OPS or a DR about an OPS, that OPS is considered to be inactive and channel re-creation is activated to rebuild the original collection. Therefore, if any of the OPSes in a tree of OPSes were to fail the computing engine of this invention is capable of re-establishing a new connection with the OPS and in the meanwhile tasks are re-routed to other OPSes in the neighborhood that can handle the work load.

DR processes are created and monitored by their master process on each computer where DRs are running. FIG. 3 shows how a given DR occupies the process space on a given computer. The master process for a given DR creates a “listener” process and number of processes called “doors.” A listener process listens for connections from clients and dispatches established connections (i.e., socket descriptors) to one of the available door processes do rest of the session handling between the DR and the client. In addition, if necessary (i.e., when session is meant for asynchronous handling) a new connection between the DR and a client is also created by the door process.

Once a connection is established between a DR and a client, future client requests are dispatched to OPSes based on rules defined for that particular DR (initially using a configuration file). The following rules are defined:
1. FAST. The DR looks for one OPS in the global neighborhood with the best resource utilization score that is capable of handling the type of task that has been requested. The request is then dispatched to it using the dynamic network topology provided to the DR.
2. ROUND ROBIN. The DR uses a round-robin algorithm to pick the OPS for a given request. Of course the OPS would also have to be capable of handling the task.
3. ALL. The DR sends the given request to all OPSes in its global neighborhood. This can be useful for performing some tasks that need to be handled by every single node, for instance, software updates etc.
4. CUSTOM. The DR evaluates a custom function defined by a user whose prototype in C programming language is as follows:
   loc_t custom_dispatch_function (int* array, size_t sz);
where, the first parameter is an array of scores of global neighborhood OPSes, the second parameter is the size of this array and the return value is the location of array entry that is to be used for dispatching the request.

Note that above rules can also be overridden by a client's context field that is associated with every request. The client may for instance, request that a request be sent to a particular OPS that it knows can handle the request. Such specific operations using the context field are allowed only for clients operating in a “super” user mode. Also note that after a client connection is made, an authorization request may be sent to the DR from the client computer. This request includes a user name and its associated encrypted password. The DR generates an internal request to authorize the user for a new session. This internal request is actually a database query request which is handled by one of the OPSes in the global neighborhood. Any request that needs to be sent would then be associated with a session in the DR the client computer is connected to.

An OPS type of server process is capable of handling broadly four types of tasks:
1. EXECUTE. The server process is capable of executing a given type of request. An execution request is itself can be of following types:
   (a) Command. A command with arguments are spawned whose exit status and output is returned to the caller.
   (b) Command in Background. A command and argument is scheduled to be handled in the background at a given time and whose output and exit status is stored either in a file on the OPS where it ran or into a row in a database.
   (c) Function. A function is read from specific dynamic library (such as a shared object or dynamically linked library) and it is called with specific arguments passed in.
2. QUERY. The server process is capable of responding with contents of persisted data sets that are subsets of a collection of data sets.
3. PERSIST. The server process is capable of persisting a collection of data sets or their sub sets.
4. REMOVE. The server process is capable of removing a collection of data sets from database files.
   Data sets that are used in QUERY, PERSIST and REMOVE operations are classified using domains. A domain in this invention is denoted by a string such as “root.subA.subB”, which is a sub-domain of “root.subA”, which itself is a sub-domain of the root domain “root”. The dot-notated domain name is considered to be fully qualified, otherwise it is considered to be unqualified domain name. Therefore, when a request is to persist a set named “root.sample.foo”, the DR will send the request only to an OPS that is capable of persisting in “root.sample” domain. This domain structure is also used when defining a topology consisting of many OPSes because all connected operations are sub or super domains of each other. This concept is similar to the domain name system (DNS) used in the internet.

RDBMS:

A relational database management system (RDBMS) is part of this invention because of the above mentioned data manipulation capabilities of an OPS. A Table in RDBMS sense is considered to be a data set whose contents are the definition of the Table such as column names, their types, constraints etc. An OPS would be capable of handling a Table such as “TableA” in a “sample” application if it has the capability of handling “root.sample” for instance. When a database look up is necessary only a QUERY type of capability for a given data set domain checked for a given OPS. Rows in a table are inserted using using typical structured query language (SQL) statements such as “INSERT”. An OPS capable of PERSIST for “root.sample” will also insert rows for “root.sample.TableA”. The rows themselves are stored as sub sets of “TableA”, i.e., as “root.sample.TableA.1123213”. When an SQL SELECT statement is issued at a later time OPSes that are capable of responding to QUERY requests for “root.sample.TableA” return all sub sets of TableA. The combined output of these sub sets form the complete response that is sent by the DR to the client. Using the rules based dispatching capabilities of DR and domain-based capabilities of OPSes we have a few ways of configuring this invention in terms of RDBMS:
1. A Fully mirrored database system with unlimited number of mirrors. This could be useful for environments that need to mirror a database across multiple computer servers simultaneously. To accomplish this a DR would have to run in “ALL” mode.
2. A striped database system. By striping a database system we mean that subsequent rows for a given table in a database are inserted into a OPSes using the round-robin rule for DR. Using this mechanism the load of retrieving data is distributed evenly across several nodes. This configuration would enable a faster data warehouse type of operations.
3. A fast striped database system. By using the FAST rule for DRs the rows for tables are distributed across OPSes based on the speed of speed of response at the time of insertion.
4. A custom striped database system. By using the custom rules for DRs an installation and a score factor configuration parameter available for OPSes, a user of this invention can customize how tables can be striped across computers. A useful case would be a optimized retrieval based scheme for dispatching rows so that insertions are not necessarily fast but queries (such as SELECT statements) would be fast according to known facts such as faster server/network etc.
5. A read-only table or an entire database system can be configured if only QUERY capability is enabled for the given table(s) in all OPSes.
   FIG. 6 shows the computing engine consisting of a single DR named DR(1) and 4 OPSes organized using domains of “A”, “A.B”, “A.C” and “A.C.Tab1”. When an EXECUTE request from a client to DR(1) is received, it dispatches it to “OPS(A.C)” via “OPS(A)” as it is the only OPS with that capability in the engine. Requests related to a table “Tab1” that is within a domain “A.C” is handled by OPS(A.C.Tab1) alone as well since there are no other OPSes that can handle DB requests for “Tab1”.

Encryption:

In the current invention encryption can be enabled at data communication as well as data persistence levels. The encryption types that are used are primarily of two types, namely, INTERNAL (using symmetric keys) and CLIENT (using asymmetric keys) based. In INTERNAL type of encryption a computer server is capable of encrypting and decrypting data using a key it shares with the decrypter or encrypter, respectively. This is a less secure method of communication but it is necessary when the encrypter also needs to decrypt the same message at a later time. For instance, when encrypted data sets are stored into files by a PERSIST capable OPS it encrypts the header portion (i.e., data consisting of name of set, time stamps etc) in the INTERNAL encryption method since when a QUERY request arrives it would need to be able to at least decrypt the header portion to evaluate its relevance.

A CLIENT based encryption is much more secure and gives only end user the capability of decrypting a message it receives from a sender. This provides the client with the power to insert a row into a table that is encrypted using the client's public key and only the client is able to retrieve contents of those rows from the given table. This type of database persistence secures a customer using this invention from physical (such as loss of hard drives etc) or network breakins.

In addition, communication between DRs and OPSes can be secured using INTERNAL or CLIENT based encryption so that DRs and OPSes could reside on remote locations connected via an insecure network channel. Therefore allowing the computing engine to grow across intranets.

Action Scripts:

The current invention provides a way to run custom scripts that can be a series of commands or functions or database related statements run in parallel or in series. This allows a client computer to access the computing engine like a virtual operating system that is capable of executing, load-balancing and loading or storing data. The scripting language that is understood by the invention here is called action scripts. The syntax is available using XML language as well as an internal parse-tree syntax such as follows:

```
(execute-stuff
  (execute (command “echo -n Got:”)
      (input
          (post-process
            “string_concatenate” “string_chomp”)
          (execute (function “parse_processes/libcustom.so”)
                  (input “parallel” (post-process “string_concatenate”)
                        (execute
                              (command “/usr/bin/ps -fu usera”))
                        (execute (command “echo -------”))
                        (execute
                              (command “/usr/bin/ps -fu userb”)))))))
```

The XML version of the script shall look like the following:

```
....
<action-script>
  <execute type=“command” value=“echo -n Got: ”>
    <input>
      <post-process name=“string_chomp” />
      <execute type=“function” value=“parse_processes/libcustom.so”>
          <input mode=“parallel”>
            <Post-process name=“string_concatenate” />
            <execute type=“command” value=“/usr/bin/ps -fu usera” />
            <execute type=“command” value=“echo -------” />
            <execute type=“command” value=“/usr/bin/ps -fu usera” />
          </input>
      </execute>
    </input>
  </execute>
</action-script>
```

In the action script shown above two commands are run in parallel on OPSes that provide the processes running in the computing environment for users “usera” and “userb.” Their outputs are concatenated along with a separator and passed in as an input for a custom function named “parse_processes” in a library “libcustom.so” that is located in a standard location. The output from this function is processed with an internal string manipulation function called “string_chomp” that removes unnecessary space from the end. Finally, the output of the entire script is printed with the “echo” command. Note, the dependencies are followed through throughout except the “ps” commands which are specified to be run in parallel.

The above example shows the EXECUTE feature of OPSes exclusively but the action scripts allow database centric commands also mixed with others. For instance, in the following script an “SQL INSERT” statement uses a value acquired from executing process listing commands for users “usera” and “userb”. The first column is also updated with the time in seconds since Jan. 1, 1970:

```
(sql (statement “INSERT into PROCS values ($, ’$’)”)
      (input
            (execute (command “date” “+%s” )))
      (input “parallel”
            (execute (command “ps -fu usera”))
            (execute (command “ps -fu userb”))))
```

1. A method for implementing a secure distributed computing engine including a distributed database system. The computing engine is capable of evaluating requests that are to be operated either in series or parallel or a complex dependency as defined using custom action scripts. In addition, the execution operations can combine with data manipulating requests.

2. The distributed database system in claim 1 is capable of being configured as mirrored, striped, fast striped and custom striped. Also a read only database system or table may be configured.

3. The topology of the computing engine in terms of the pool of computers is dynamically healed by the channels that are created when the topology is defined. In other words, when any of the computers in the computing engine goes down, the resources are automatically routed to other capable computers and the connection is re-established when the computer is back on the network.

4. The computing engine framework is capable of dispatching requests to participating computers using rules that are for fastest execution, redundant execution or custom logic based execution.

5. Secure modes of encryption is used for the computing engine for both data transmission as well as data persistence when needed. CLIENT based encryption for individual rows in a database table are also available. Only the calling client is capable of decrypting rows that it inserts into a table using a CLIENT based data persistence mode.

6. The computing engine is extensible and organized using domains that can be created dynamically without having to shutdown the entire engine. A sub-domain can be added by only shutting down the OPS that shall be its immediate parent domain. A root level domain can be added during run-time by only shutting down the immediate DOOR dispater server.

7. In addition to claim 6, the invention modifies and heals its topology automatically because of timely internal messages, channel monitoring built into server processes and domains.
